(19) United States
(12) Patent Application Publication
(10) Pub. No.: US 2011/0271065 A1
(43) Pub. Date: Nov. 3, 2011

(54) STORAGE SYSTEM FRONT END WITH PROTOCOL TRANSLATION

(75) Inventors: Guy David FRICK, Lafayette, CO (US); Samuel Burk SIEWERT, Erie, CO (US)

(73) Assignee: Assurance Software and Hardware Solutions LLC, Louisville, CO (US)

(21) Appl. No.: 13/180,222

(22) Filed: Jul. 11, 2011

Related U.S. Application Data
(63) Continuation of application No. 12/395,509, filed on Feb. 27, 2009.
(60) Provisional application No. 61/032,865, filed on Feb. 29, 2008.

(51) Int. Cl. G06F 12/00; G06F 9/46

(52) U.S. Cl. 711/154; 719/328; 711/E12.001

(57) ABSTRACT

A storage system may include a first storage device and a protocol translator. The protocol translator may be programmed to receive a storage-access command formatted in a first protocol format. The protocol translator may also be programmed to translate the storage-access command into a second protocol format. The storage system may include a pseudo-target-module coupled to the protocol translator. The pseudo-target module may be programmed to send the command to the first storage device after the command is translated into the second protocol format. A virtualization engine may provide an interface to the first storage device, and the storage-access command may be sent to the first storage device through the virtualization engine. The pseudo-target module may be programmed to receive data from both storage-area-network devices and network-attached-storage devices.

### CROSS-REFERENCE TO RELATED PATENT APPLICATIONS

This application is a continuation of copending U.S. patent application Ser. No. 12/395,509, filed on Feb. 27, 2009, which claims priority from U.S. provisional patent application No. 61/032,865 filed on Feb. 29, 2008, the entire disclosures of which are incorporated herein by reference.

### BACKGROUND

Massive amounts of data storage may be needed for many emerging and existing applications. For example, video-on-demand applications may provide access to hundreds or thousands of movies for hundreds or thousands of users simultaneously. These video-on-demand applications may require vast amounts of digital storage, fast access, 24 hours-per-day and 7 days per week (24/7) availability and uptime, and substantial bandwidth. Modern supercomputers may also need these features, and may require extraordinary data integrity, error checking, and error correction.

One traditional solution to provide massive amounts of data storage is a conventional rack-mount disk-drive enclosure, which may arrange a number of disk drives (e.g. 3 to 14) in a removable carrier. These disk-drive enclosures may often be installed in a preexisting infrastructure that may use a number of different transport protocols to transfer data. However, traditional disk-drive enclosures may only support a single protocol and may require a protocol converting switch or other modifications to work with a preexisting infrastructure. Traditional disk-drive enclosures may also have many other deficiencies that keep them from meeting increasing data storage demands for many applications.

### SUMMARY

The instant disclosure presents various storage systems and methods. In some embodiments, a storage system may include a protocol translator. The protocol translator may be programmed to receive a storage-access command formatted in a first protocol format and translate the storage-access command into a second protocol format. Thus, the protocol translator may be programmed to translate storage-access commands from two or more different protocols into a single protocol. A protocol translator may therefore provide a protocol agnostic front end for a storage system.

In certain embodiments, the protocol translator may be coupled to a pseudo-target module. The pseudo-target module may be programmed to transfer the storage-access command from the protocol translator to a storage device. In at least one embodiment, a virtualization engine may provide an interface between the pseudo-target module and the protocol translator. The storage system may also include a mid-level interface that may transfer the storage-access command from the protocol translator to the pseudo-target module.

According to various embodiments, the pseudo-target module may be programmed to communicate with both a Storage-Area-Network (SAN) interface and a Network-Attached-Storage (NAS) interface. The pseudo-target module may provide SAN/NAS convergence. The pseudo-target module may also be configured to receive, from an initiator, a request to access a first storage device. The pseudo-target module may access the first storage device and a second storage device in response to the request, and the access to the second storage device may be transparent to the initiator.

The storage devices presented herein may include a data-storage enclosure. A plurality of hard-disk drives may be positioned in the data-storage enclosure. In some embodiments, the data-storage enclosure may be configured as a high-density data-storage enclosure. Embodiments of the present disclosure may also be implemented in various other devices and systems and may comprise various other features and advantages.

### BRIEF DESCRIPTION OF DRAWINGS

The accompanying drawings illustrate a number of exemplary embodiments and are a part of the specification. Together with the following description, these drawings demonstrate and explain various principles of the instant disclosure.

FIG. 1 is a block diagram of an exemplary storage system according to certain embodiments.

FIG. 2 is a block diagram of another exemplary storage system according to certain embodiments.

FIG. 3 is a flow diagram of an exemplary method for managing access to a storage system according to certain embodiments.

FIG. 4 is a block diagram of an exemplary storage system according to certain embodiments.

FIG. 5 is a block diagram of another exemplary storage system according to certain embodiments.

FIG. 6 is a flow diagram of an exemplary method for performing device bridging according to certain embodiments.

FIG. 7 is a diagram showing exemplary communications between components of a front end of a storage system according to certain embodiments.

FIG. 8 is a perspective view of an exemplary storage system according to certain embodiments.

FIG. 9 is a block diagram of exemplary computing network capable of implementing one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The following is intended to provide a detailed description of various exemplary embodiments and should not be taken to be limiting in any way. Various exemplary storage device methods and systems are disclosed herein. In some embodiments, a storage system may comprise a protocol translator. The protocol translator may be programmed to receive a storage-access command formatted in a first protocol format and translate the storage-access command into a second protocol format. The storage system may also comprise a pseudo-target module. The pseudo-target module may be coupled to a virtualization engine of a first storage device of the storage system. In some embodiments, the pseudo-target module may be programmed to communicate with both a storage-area-network (SAN) interface and a network-attached-storage (NAS) interface. The pseudo-target module may also be programmed to perform device bridging. Embodiments of the instant disclosure may also provide various other features and advantages over prior storage systems.

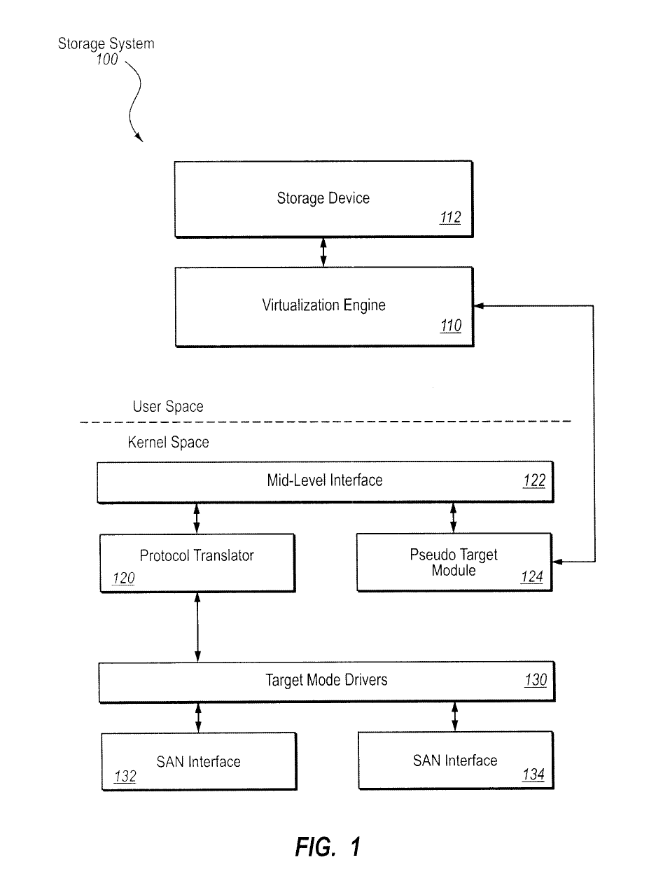

FIG. 1 shows a storage system 100. Storage system 100 may include a storage device 112 and a virtualization engine 110 in the user space of storage system 100. Virtualization engine 110 may provide an interface for storage device 112. Storage device 112 may be any suitable storage device, such as a hard-disk drive or a tape drive. Storage system 100 may include a plurality of storage devices, and storage device 112 may be a storage device in the plurality of storage devices. Virtualization Engine 110 may provide an interface to the plurality of storage devices.

Storage system 100 may also include a mid-level interface 122, a protocol translator 120, and a pseudo-target module 124 in the kernel space of storage system 100. Mid-level interface 122 may provide an interface for communications between protocol-translator 120 and pseudo-target module 124. Mid-level interface 122 may be a small-computer-system-interface (SCSI) interface. Mid-level interface 122 may also be an interface that supports any other suitable protocol. FIG. 1 also shows that pseudo-target module 124 may be coupled to virtualization engine 10, and protocol translator 120 may be coupled to target mode drivers 130. Target mode drivers 130 may be drivers for a SAN interface 132 and a SAN interface 134.

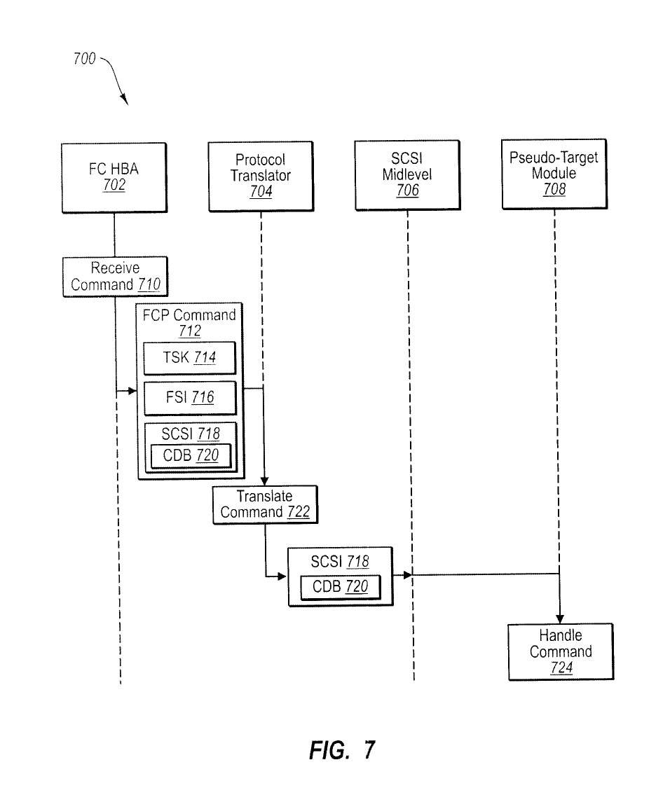

SAN interfaces 132 and 134 may be configured for different transport protocols. For example, SAN interface 132 may be an internet Small-Computer-System-Interface (iSCSI) interface while SAN interface 134 may be a Fibre Channel (FC) interface. In prior systems, in order to receive commands formatted in different protocols, an administrator may have installed a transfer-protocol-converting switch in order to convert transfer protocols before they arrived at the storage system. In contrast, in some embodiments, virtualization engine 110 may be programmed to communicate with commands formatted in accordance with various different transport protocols. However, programming virtualization engine 110 to support numerous transport protocols may result in a resource-intensive virtualization engine with a relatively large footprint. Protocol translator 120 may solve this problem by performing protocol translations on storage-access commands after they arrive at storage system 100 but before they are sent to virtualization engine 110, thereby allowing virtualization engine 110 to be less resource intensive and provide a smaller footprint. FIG. 7 provides additional details of an example of translating a command from one protocol to another protocol.

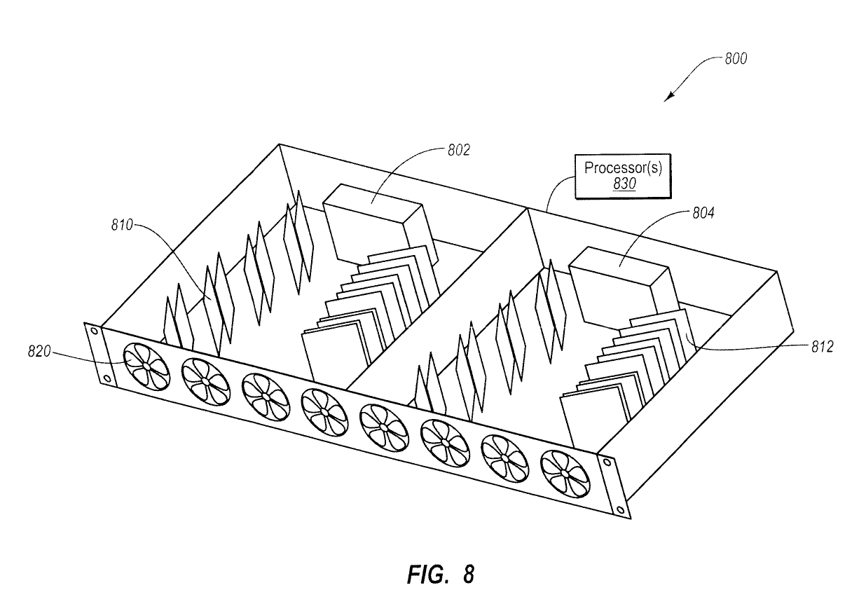

Virtualization engine 110 may be any suitable virtualization system for providing an interface to storage device 112. For example, virtualization engine 110 may abstract logical storage from physical storage. In some embodiments, virtualization engine 110 may be an ATRATO™ virtualization engine that provides access to a Single Array of Identical Disks (SAID). FIG. 8 illustrates an example of a SAID storage system, and SAN interfaces 132 and 134, target mode drivers 130, protocol translator 120, mid-level interface 122, and pseudo-target module 124 may comprise a front end of a SAID storage system.

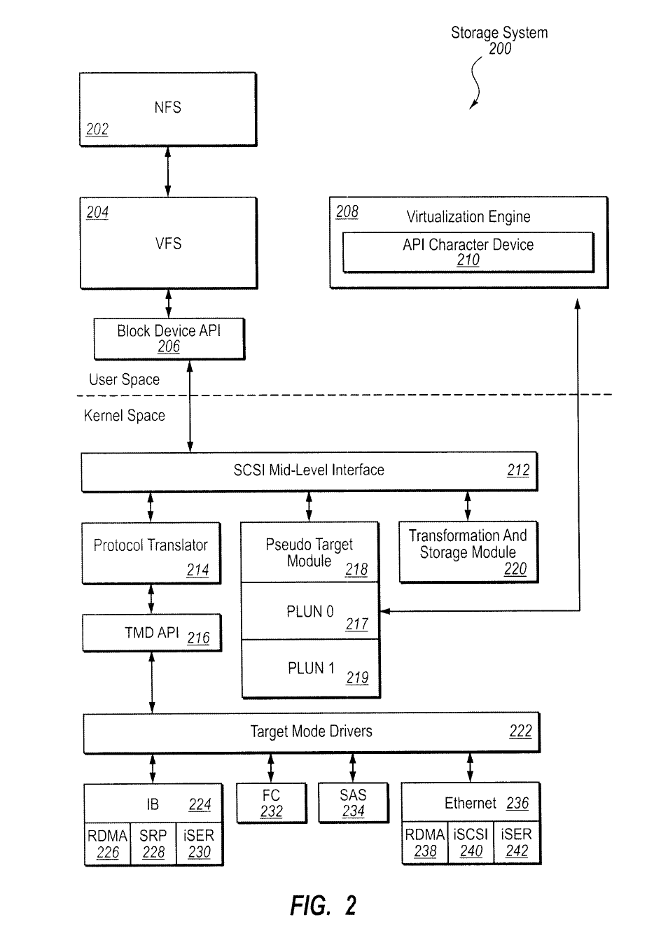

FIG. 2 illustrates a storage system 200. Storage system 200 may include a virtualization engine 208 with an application programming interface (API) character device 210 in user space of storage system 200. Storage system 200 may also include a block device API 206 in communication with a virtual file system 204. Virtual file system 204 may provide an interface for a network file system 202. Storage system 200 may also include a SCSI mid-level interface 212, a protocol translator 214, a pseudo-target module 218, and a transformation and storage module 220. Pseudo-target module 218 may include or be in communication with a logical unit number (LUN) database, which may identify a pseudo LUN_0 (pLUN_0) 217 and a pLUN_1 219. Pseudo-target module 218 may also be associated with any number of additional LUNs.

Protocol translator 214 may communicate with target mode drivers 222 through a target mode driver API 216. Target mode drivers 222 may be drivers for various network interfaces, such as InfiniBand (IB) interfaces, fibre channel interfaces, serial attached SCSI (SAS) interfaces, Ethernet interfaces, and/or any other types of network interfaces. As shown, storage system 200 may include IB interfaces 224, such as a remote direct memory access (RDMA) interface 226, a SCSI remote protocol (SRP) interface 228, and an iSCSI RDMA (iSER) interface 230. Storage system 200 may also include a fibre channel interface 232, a serial attached SCSI (SAS) interface 234, and an Ethernet interface 236. Ethernet interface 236 may comprise an RDMA interface 238, and iSCSI interface 240, and an iSER interface 242.

Each of the SAN interfaces illustrated in FIG. 2 may communicate with protocol translator 214 through a target-mode driver and a target-mode driver application programming interface (TMD API) 216. Protocol translator 214 may communicate with SAN interfaces with different protocols and may translate commands of different protocols into a single language understood by a SCSI mid-level interface 212. As previously noted, this functionality of protocol translator 214 may allow virtualization engine 208 to have a smaller footprint for memory and resource consumption by removing the requirement for virtualization engine 208 to speak numerous protocol languages.

Pseudo-target module 218 may talk directly to virtualization engine 208 or may initialize data transformation using transformation and storage module 220. After transformation and storage module 220 transforms the data, pseudo-target module 218 may transfer the data to pLUN_0 217 (i.e., virtualization engine 208). In other embodiments, after transformation and storage module 220 transforms the data, pseudo-target module 218 may transfer the data to a different storage device, (e.g., pLUN_1 219). Pseudo-target module 218 may also store the transformed data back out across the network (e.g., to a SCSI or InfiniBand network). Thus, pseudo-target module 218 may function as a mid-point data transformation and forward module.

In some embodiments, pseudo-target module 218 may perform device bridging. A LUN underneath pseudo-target module 218 may be able to talk to other LUNs in a manner that is transparent to an initiator of a storage access request. For example, pLUN_0 217 may receive all the requests from the protocol translator 214. pLUN_0 217 may talk to pLUN_1 219 in a manner that is transparent to the initiator and to protocol translator 214. Thus, the initiator may not need to know about multiple devices on the network. In other words, pLUN_1 219 may be hidden behind the pLUN_0 217. As an example, an initiator may request a write to pLUN_0 217, which may be a disk. pLUN_0 may also cause the data to be written to pLUN_1 219, which may be a tape, but the initiator may not know that the data is being written to tape as well as to disk. This type of device bridging may reduce network traffic and provide efficient backup functionality. Device bridging may also facilitate cashing information or any other suitable device bridging function.

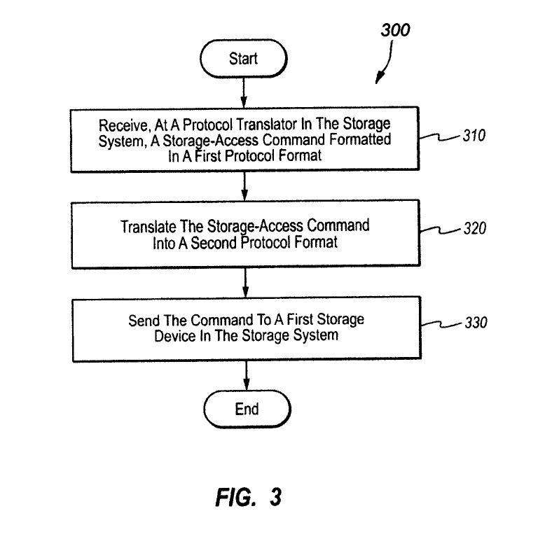

FIG. 3 is a flow diagram of an exemplary computer-implemented method 300 for managing access to a storage system. A protocol translator in the storage system may receive a storage-access command formatted in a first protocol format (step 310). The storage-access command may be a request to read data from a storage device, write data to the storage device, or perform any other data management or manipulation operation. The first protocol format may be an iSCSI protocol format, an IB protocol format, an SAS protocol format, an FC protocol format, or any other transport protocol format.

After receiving the storage-access command, the protocol translator may translate the storage-access command into a second protocol format (step 320). In some embodiments, the protocol translator may translate the storage-access command into the second protocol format by extracting essential information from the command it receives. The protocol translator may also encapsulate the essential information in a command understood by a virtualization engine of the storage device. Alternatively, the protocol translator may remove transport-specific information from the command. The protocol translator may then send the command to a first storage device in the storage system (step 330). The command may be sent from the protocol translator to the storage device through a pseudo-target module and/or a virtualization engine.

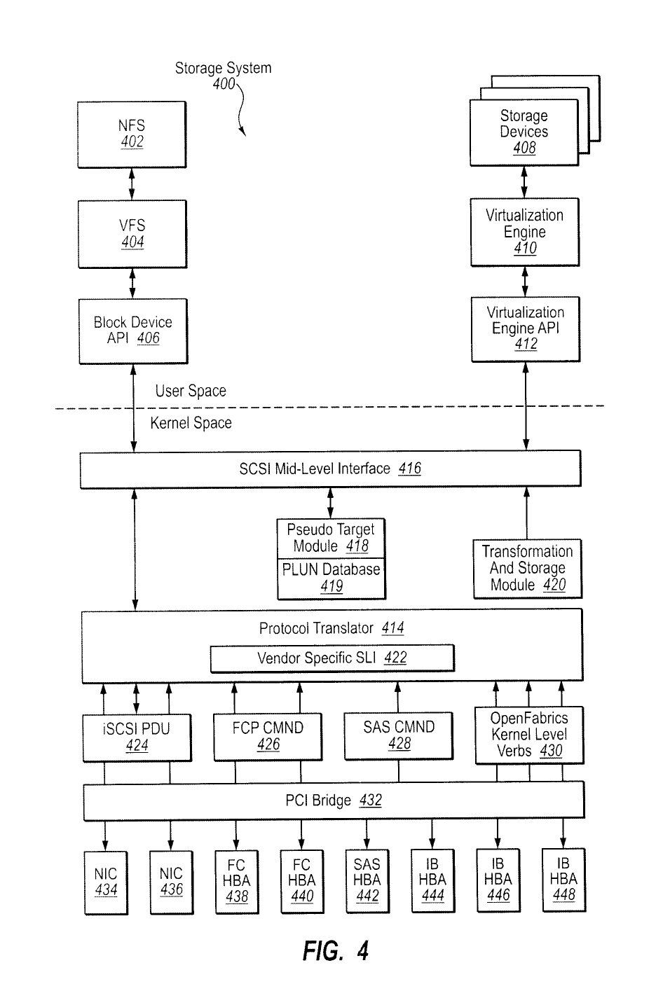

FIG. 4 is a block diagram of a storage system 400. Storage system 400 may include a NAS with a network file system 402, a virtual file system 404, and a block device API 406. Block device API 406 may communicate with a SCSI mid-level interface 416. SCSI mid-level interface 416 may also communicate with a virtualization engine 410 through a virtualization engine API 412. Virtualization engine 410 may provide an interface to storage devices 408. Storage devices 408 may comprise a SAID.

Storage system 400 may also include a protocol translator 414. In some embodiments, however, a storage system may not necessarily include a protocol translator. In storage system 400, protocol translator 414 may communicate with a pseudo-target module 418 through SCSI mid-level interface 416. Pseudo-target module 418 may comprise a pLUN database 419. Pseudo-target module 418 may also communicate with a transformation and storage module 420 through SCSI mid-level interface 416.

FIG. 4 shows that network interface card (NIC) 434 and network interface card 436 may communicate iSCSI protocol data units (PDUs) 424 to protocol translator 414 through a PCI Bridge 432. Similarly, fibre channel host bus adapter (HBA) 438 and fibre channel host bus adapter (HBA) 440 may communicate fibre channel protocol commands 426 to protocol translator 414 through PCI bridge 432. Also, InfiniBand host channel adapter (HCA) 444 host channel adapter 446, and host channel adapter 448 may communicate OpenFabrics kernel level verbs 430 to protocol translator 414 through PCI bridge 432. Serial attached SCSI (SAS) HBA 442 may communicate an SAS command to protocol translator 414 through PCI bridge 432. Protocol translator 414 may translate each of these commands into a SCSI command understood by pseudo-target module 418.

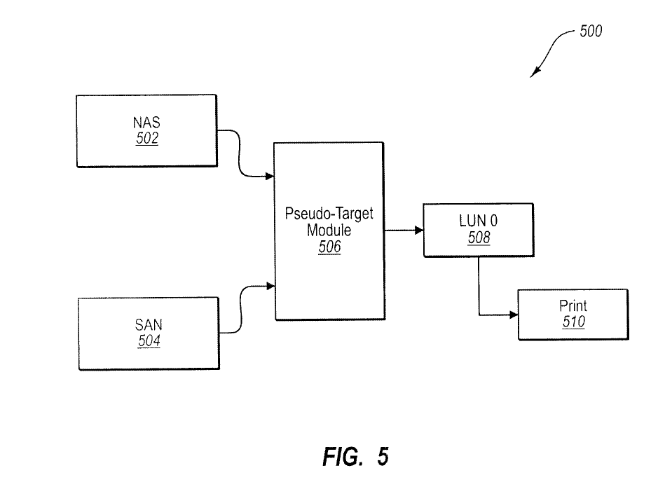

FIG. 5 illustrates a storage system 500 with a pseudo-target module 506. Pseudo-target module 506 may be programmed to communicate with both a NAS system 502 and a SAN system 504. In other words, pseudo-target module 506 may provide for SAN/NAS convergence in storage system 500. For example, users on NAS 502 may need to access data being dumped on LUN_0 508 from SAN 504. However, the NAS users may not want to wait until the data transfer to LUN_0 508 is complete before working on the data (e.g., the data may be video data that may take hours to transfer to LUN_0 508). In some embodiments, the NAS users may begin processing (e.g., rendering) the data once a data transfer threshold is met. In other words, the NAS users may begin processing the data once a certain amount of data is transferred from SAN 504 to LUN_0 508.

The previous example shows that pseudo-target module 506 may allow users to read data and render data though NAS 502 while the data is being received through SAN 504. In some embodiments, as the data is processed, the data may be sent back from NAS 502 to LUN_0 508. In other words, as data is received from SAN 504, NAS users may process the data and send it back to LUN_0 508. LUN_0 508 may also provide data print functionality 510.

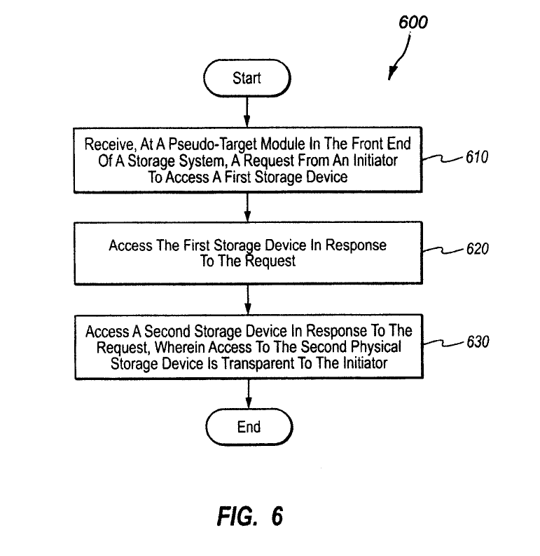

FIG. 6 illustrates a computer-implemented method 600 for providing device bridging. A pseudo-target module in the front end of a storage system may receive a request to access a first storage device from an initiator (step 610). The pseudo-target module may access the first storage device in response to the request (step 620). The pseudo-target module may also access a second storage device in response to the request (step 630). In some embodiments, access to the second physical storage device may be transparent to the initiator.

FIG. 7 illustrates exemplary communications between devices and modules in a storage system front end 700. A fibre channel HBA 702 may receive a fibre channel protocol (FCP) command 712 (step 710). The fibre channel HBA may send FCP command 712 to a protocol translator 704. FCP command 712 may include a TSK block 714, an FSI block 716, and a SCSI block 718. SCSI block 718 may include a command descriptor block (CDB) 720. Protocol translator 704 may remove the encapsulation of SCSI command 718 to leave just SCSI command 718 with CBD 720 (step 722). Then, protocol translator 704 may send SCSI command 718 to a pseudo-target module 708 through a SCSI midlevel interface 706. Pseudo-target module 708 may then handle SCSI command 718 (step 724).

FIG. 8 illustrates an exemplary storage system 800. Storage system 800 may include disk drives 810 and 812 placed in a herringbone physical-layout pattern. Storage system 800 may include a processor 830 that may run one or more of the modules discussed herein. Storage system 800 may also include physical interfaces that allow storage system 800 to connect to a network or to other storage devices. Two or more power supplies 802 and 804 may provide redundant power for the disk drives 810. Also, fans 820 may provide air circulation through storage system 800.

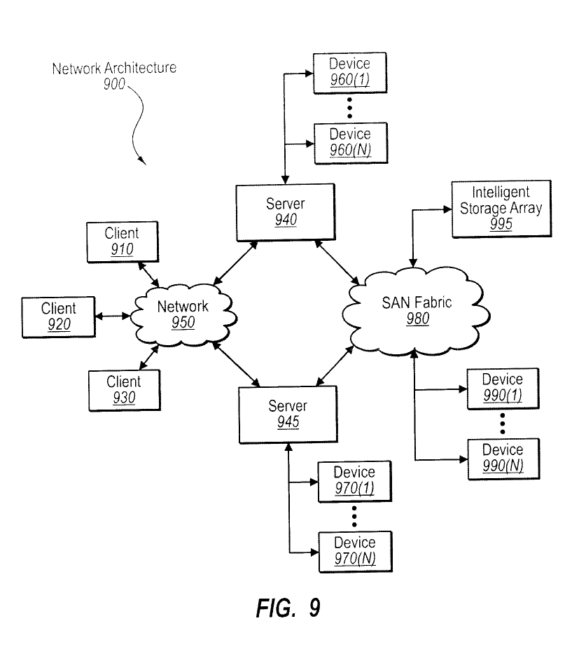

FIG. 9 is a block diagram of an exemplary network architecture 900 in which client systems 910, 920, and 930 and servers 940 and 945 may be coupled to a network 950. Client systems 910, 920, and 930 generally represent any type or form of computing device or system. Similarly, servers 940 and 945 generally represent computing devices or systems, such as application servers or database servers configured to provide various database services and/or to run certain software applications. Network 950 generally represents any telecommunication or computer network; including, for example, an intranet, a wide area network (WAN), a local area network (LAN), a personal area network (PAN), or the Internet.

As illustrated in FIG. 9, one or more storage devices 960(1)-(N) may be directly attached to server 940. Similarly, one or more storage devices 990(1)-(N) may be directly attached to server 945. Storage devices 960(1)-(N) and storage devices 990(1)-(N) generally represent any type or form of storage device or medium capable of storing data and/or other computer-readable instructions. In certain embodiments, storage devices 960(1)-(N) and storage devices 990(1)-(N) may represent network-attached storage (NAS) devices configured to communicate with servers 940 and 945 using various protocols, such as NFS, SMB, or CIFS.

Servers 940 and 945 may also be connected to a storage area network (SAN) fabric 980. SAN fabric 980 generally represents any type or form of computer network or architecture capable of facilitating communication between a plurality of storage devices. SAN fabric 980 may facilitate communication between servers 940 and 945 and a plurality of storage devices 990(1)-(N) and/or an intelligent storage array 995. SAN fabric 980 may also facilitate, via network 950 and servers 940 and 950, communication between client systems 910, 920, and 930 and storage devices 990(1)-(N) and/or intelligent storage array 995 in such a manner that devices 990(1)-(N) and array 995 appear as locally attached devices to client systems 910, 920, and 930. As with storage devices 960(1)-(N) and storage devices 970(1)-(N), storage devices 990(1)-(N) and intelligent storage array 995 generally represent any type or form of storage device or medium capable of storing data and/or other computer-readable instructions.

In certain embodiments, a communication interface may be used to provide connectivity between each client system 910, 920, and 930 and network 950. Client systems 910, 920, and 930 may be able to access information on server 940 or 945 using, for example, a web browser or other client software. Such software may allow client systems 910, 920, and 930 to access data hosted by server 940, server 945, storage devices 960(l)-(N), storage devices 970(1)-(N), storage devices 990(1)-(N), or intelligent storage array 995. Although FIG. 9 depicts the use of a network (such as the Internet) for exchanging data, the embodiments described and/or illustrated herein are not limited to the Internet or any particular network-based environment.

In at least one embodiment, all or a portion of one or more of the exemplary embodiments disclosed herein may be encoded as a computer program and loaded onto and executed by server 940, server 945, storage devices 960(1)-(N), storage devices 970(1)-(N), storage devices 990(1)-(N), intelligent storage array 995, or any combination thereof. All or a portion of one or more of the exemplary embodiments disclosed herein may also be encoded as a computer program, stored in server 940, run by server 945, and distributed to client systems 910, 920, and 930 over network 950. Accordingly, network architecture 900 may perform and/or be a means for performing, either alone or in combination with other elements, one or more of the detecting, storing, using, preventing, permitting, overwriting, editing, determining, ignoring, and hooking steps disclosed herein. Network architecture 900 may also be used to perform and/or be a means for performing other steps and features set forth in the instant disclosure.

For example, in certain embodiments the exemplary file systems disclosed herein may be stored on client systems 910, 920, and/or 930. Similarly, the exemplary file-system backups disclosed herein may be stored on server 940, server 945, storage devices 960(1))-(N), storage devices 970(1)-(N), storage devices 990(1)-(N), intelligent storage array 995, or any combination thereof.

According to various embodiments, the storage systems described herein may be part of network architecture 900 and/or the devices corresponding to network architecture 900. In some embodiments, a storage system may comprise a first storage device. The storage system may also comprise a protocol translator. The protocol translator may be programmed to receive a storage-access command formatted in a first protocol format. The protocol translator may also be programmed to translate the storage-access command into a second protocol format. The storage system may comprise a pseudo-target module coupled to the protocol translator. The pseudo-target module may be programmed to send the command to the first storage device after the command is translated into the second protocol format.

According to certain embodiments, the storage system may comprise a virtualization engine. The virtualization engine may provide an interface to the first storage device. The storage-access command may be sent to the first storage device through the virtualization engine. According to at least one embodiment, the second protocol format may comprise a SCSI format. In at least one embodiment, the pseudo-target module may be configured to receive data from both storage-area-network devices and network-attacked-storage devices.

In some embodiments, the storage system of claim 1 may further comprise a SCSI mid-level interface configured to transfer the storage-access command from the protocol translator to the pseudo-target module. The pseudo-target module may be a kernel-level module. In some embodiments, the storage system may further comprise an internet iSCSI input and a fibre-channel input. The first protocol format may comprise a fibre-channel protocol format.

The storage system may comprise a target-mode-driver application programming interface configured to provide an interface between the protocol translator and a plurality of target mode drivers. In some embodiments, the plurality of target mode drivers may comprise at least one of: a fiber-channel target-mode driver, an iSCSI target mode driver, an infiniband target-mode driver, and/or an SAS target-mode driver.

In some embodiments, the storage system may comprise a data-storage enclosure. The storage system may also comprise a plurality of hard-disc drives positioned in the data-storage enclosure. The plurality of hard-disc drives may comprise the first storage device. In some embodiments, the storage device may comprise a front end. The front end may comprise the pseudo-target-module and the protocol translator.

According to at least one embodiment, the pseudo-target-module may be programmed to receive commands from both a SAN system and a NAS system. According to various embodiments, the pseudo-target-module may be programmed to receive a request to access the first physical storage device from an initiator. The pseudo-target-module may also be programmed to access both the first storage device and a second storage device in response to the request. Access to the second storage device may be transparent to the initiator.

According to certain embodiments, a computer-implemented method for managing access to a storage system may comprise receiving, at a protocol translator in a storage system, a storage-access command formatted in a first protocol format. The computer-implemented method may also comprise translating the storage-access command into a second protocol format and sending the command to a first storage device in the storage system.

In some embodiments, sending the storage-access command to the first storage device may comprise sending the storage-access command to a virtualization engine that provides an interface for the first storage device. The second protocol format may comprise a SCSI protocol format. In some embodiments, sending the command to the virtualization engine may comprise sending the command from the protocol translator to the virtualization engine through a pseudo-target-module.

In various embodiments, the pseudo-target-module may be configured to receive data from both SAN devices and NAS devices. In various embodiments, the pseudo-target-module may be a kernel-level module. In some embodiments, a storage system may comprise a first storage device. The storage system may also comprise a virtualization engine that provides an interface to the first storage device. The storage system may also comprise a pseudo-target-module coupled to the virtualization engine. The pseudo-target-module may be programmed to communicate with a SAN interface and a NAS interface.

In some embodiments, a NAS system may comprise the NAS interface and a network file system. The NAS system may also comprise a virtual file system. In some embodiments the storage system may comprise the SAN interface. The SAN interface may comprise at least one of: a fibre channel host-bus adaptor, an internet small-computer-system-interface card, a serial-attached internet small-computer-system-interface host-bus adaptor, and/or an infiniband host channel adaptor.

In at least one embodiment, the storage system may comprise a protocol translator. The protocol translator may be configured to receive a storage-access command formatted in a first protocol format. The protocol translator may also be programmed to translate the storage-access command into a second protocol format. The pseudo-target-module may be coupled to the protocol translator and configured to send a storage-access command to the first storage device after the storage-access command is translated into the second protocol format.

In some embodiments, the pseudo-target-module may be programmed to receive a request to access the first storage device from an initiator. The pseudo-target-module may also be programmed to access both the first storage device and a second storage device in response to the request. Access to the second storage device may be transparent to the initiator.

According to certain embodiments, a storage system may comprise a first storage device and a virtualization engine. The virtualization engine may provide an interface to the first storage device. The storage system may also comprise a first pseudo-target-module coupled to the virtualization engine. The pseudo-target-module may be programmed to receive a request to access the first storage device from an initiator. The pseudo-target-module may also be programmed to access the first storage device and a second storage device in response to the request. Access to the second storage device may be transparent to the initiator.

In some embodiments, the pseudo-target module may be programmed to receive data from both SAN devices and NAS devices. The storage system may also comprise a small-computer-system-interface mid-level interface configured to transfer the command from a protocol translator to the pseudo-target module. In some embodiments, the pseudo-target module and the protocol translator may be kernel-level modules.

The storage system may further comprise a data-storage enclosure. The storage system may also comprise a plurality of hard-disc drives positioned in the data-storage enclosure. The plurality of hard-disc drives may comprise the first storage device. In some embodiments, the storage system may include a front end. The front end may comprise the pseudo-target module.

According to certain embodiments, a computer-implemented method may comprise receiving a request from an initiator to access a first storage device. The request may be received at a pseudo-target module in the front end of a storage system. The computer-implemented method may also comprise accessing the first storage device in response to the request. The computer-implemented method may comprise accessing the second storage device in response to the request. Access to the second storage device may be transparent to the initiator.

In some embodiments, the pseudo-target module may be configured to receive data from both SAN devices and NAS devices. In various embodiments, the storage system may further comprise a data-storage enclosure and a plurality of hard-disc drives positioned in the data-storage enclosure. The plurality of hard-disc drives may comprise the first storage device.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

What is claimed is:

1. A storage system comprising: a pseudo-target module coupled to the protocol translator, the pseudo-target module being programmed to send the command to the first storage device after the command is translated into the second protocol format.
a first storage device;
a protocol translator, the protocol translator being programmed to:
receive a storage-access command formatted in a first protocol format;
translate the storage-access command into a second protocol format; and
a pseudo-target module coupled to the protocol translator, the pseudo-target module being programmed to send the command to the first storage device after the storage-access command is translated into the second protocol format.

2. The storage system of claim 1, further comprising a virtualization engine providing an interface to the first storage device, wherein the storage-access command is sent to the first storage device through the virtualization engine.

3. The storage system of claim 1, wherein the second protocol format comprises a small-computer-system-interface format.

4. The storage system of claim 1, wherein the pseudo-target module is programmed to receive data from both storage-area-network devices and network-attached-storage devices.

5. The storage system of claim 1, further comprising a small-computer-system-interface mid-level interface configured to transfer the storage-access command from the protocol translator to the pseudo-target module.

6. The storage system of claim 1, wherein the pseudo-target module and the protocol translator are kernel-level modules.

7. The storage system of claim 1, further comprising:
an internet small-computer-system-interface input; and
a fiber-channel input, the first protocol format comprising a fiber-channel protocol format.

8. The storage system of claim 7, further comprising a target-mode-driver application programming interface configured to provide an interface between the protocol translator and a plurality of target mode drivers.

9. The storage system of claim 8, wherein the plurality of target mode drivers comprises at least one of:
a fiber-channel target-mode driver, the fiber-channel target mode driver being programmed to interface between the target-mode-driver application programming interface and the fiber-channel input;
an internet small-computer-system-interface target-mode driver, the internet small-computer-system-interface target-mode driver being programmed to interface between the target-mode-driver application programming interface and the internet small-computer-system-interface input;
an infiniband target-mode driver, the infiniband target mode driver being programmed to interface between the target-mode-driver application programming interface and an infiniband input; and
a serial-attached small-computer-system-interface target-mode driver, the serial-attached small-computer-system-interface target-mode driver being programmed to interface between the target-mode driver application programming interface and the serial-attached small-computer-system-interface input.

10. The storage system of claim 1, further comprising a data-storage enclosure; and a plurality of hard-disk drives positioned in the data-storage enclosure, the plurality of hard-disk drivers comprising the first storage device.

11. The storage system of claim 1, further comprising a front end, the front end comprising the pseudo-target module and the protocol translator.

12. The storage system of claim 1, wherein the pseudo-target module is programmed to receive a request to access the first physical storage device from an initiator, and access both the first storage device and a second storage device in response to the request, wherein access to the second storage device is transparent to the initiator.

13. A storage system comprising: access the first storage device and a second target in response to the request, wherein access to the second storage device is transparent to the initiator.
a first storage device;
a virtualization engine that provides an interface to the first storage device;
a first pseudo-target module coupled to the virtualization engine, the pseudo-target module being programmed to:
receive a request to access the first storage device from an initiator; and
access the first storage device and a second target in response to the request, wherein access to the second storage device is transparent to the initiator.

14. The storage system of claim 13, wherein the pseudo-target module is programmed to receive data from both storage-area-network devices and network-attached storage devices.

15. The storage system of claim 13, further comprising a small-computer-system-interface mid-level interface configured to transfer the command from a protocol translator to the pseudo-target module.

16. The storage system of claim 13, wherein the pseudo-target module and the protocol translator may be kernel-level modules.

17. The storage system of claim 13, further comprising a data-storage enclosure, and a plurality of hard-disk drives positioned in the data-storage enclosure, the plurality of hard-disk drives comprising the first storage device.

18. The storage system of claim 13, further comprising a front end, the front end comprising the pseudo-target module.

19. A computer-implemented method comprising:
receiving, at a pseudo-target module in the front end of a storage system, a request from an initiator to access a first storage device;
accessing the first storage device in response to the request; and
accessing a second storage device in response to the request, wherein access to the second storage device is transparent to the initiator.

20. The computer-implemented method of claim 19, wherein the pseudo-target module is configured to receive data from both storage-area-network devices and network-attached-storage devices.

21. The computer-implemented method of claim 19, wherein the storage system further comprises a data-storage enclosure, and a plurality of hard-disk drives positioned in the data-storage enclosure, the plurality of hard-disk drives comprising the first storage device.
